(19) United States
(12) Patent Application Publication
(10) Pub. No.: US 2021/0349375 A1
(43) Pub. Date: Nov. 11, 2021

(54) A COLLAPSIBLE HOLLOW LIGHT REFLECTOR

(71) Applicant: Vasyl NYKOLYSHYN, Rajadiriya (LK)

(72) Inventor: Vasyl NYKOLYSHYN, Ivano-Frankivsk (UA)

(21) Appl. No.: 16/319,924

(22) PCT Filed: Sep. 8, 2017
(86) PCT No.: PCT/IB2017/055415

§ 371 Date: Jan. 23, 2019

(51) Int. Cl. G03B 15/06; F21V 7/18; F21V 7/00

(52) U.S. Cl. CPC G03B 15/06; F21V 7/0008; F21V 7/18

(57) ABSTRACT

When light comes from a direct source onto an object it comes in a straight line and can produce harsh, hard shadows on a subject. When light is bounced off of a second surface the angle and the size of the surfaces defines the scope of the light and the ability to light up the object from numerous angles. Hence, the extensive the area of the reflector, and multiple the angles, the better the quality of the picture. However, large sized reflectors have a disadvantage in mobility. Moreover, large sized reflectors and conventional reflectors are wind-resistant causing the reflector to waver and become uncontrollable to handle particularly in windy or outdoor use. Light modifying and reflecting tools that expand lighting options for photographers, particularly in outdoor use for ease of mobility and wind permeability.

### FIELD OF INVENTION/TECHNICAL FIELD

The present invention relates to a collapsible light modifier and reflector in the photography and motion picture field, in particular for modifying and conveyance of light produced by a lighting source to an object and collapsible when not in use.

### BACKGROUND OF THE INVENTION

In the photography and motion picture field light plays a major role in obtaining a clear, quality picture of the object. A direct light source creates harsh shadows whereas when a light bounces off a surface it distributes light from the full surface of the reflector, creating not one large light source, but a lot of small light sources spread out. As a result, it becomes a 3-dimensional light that gives a very unique quality of light especially suitable for fabrics, fashion photography etc. where preserving color and details is of essence. A solid light source of the same size would wash off colors and have far less details. Therefore, spreading out the light source and the angles from which an object is illuminated are critical factors in obtaining a quality picture. The area of the reflecting surface contributes to the spreading out of the light whilst the angles intensify the 3-dimensional effect. Consequently a large reflecting surface would give a higher quality picture than a smaller surface. However, large reflectors not only require a large surface area, but also a large structure to hold the reflecting surface. Yet, larger the surface and the structure the more difficult it is to be used, handled and transported. Therefore, managing the size of the reflecting surface and the structure or frame holding it becomes crucial especially in outdoor shootings where the reflector needs to be transported, set up, moved while shooting and collapsed and stored when not in use. Moreover larger the surface and the structure, the more resistant it is to wind, causing it to waver and become difficult to hold in place, and flicker the light, resulting in diminished quality of the picture taken.

### BACKGROUND ART

The light sources that directly emit light have now been outdone by some of the conventional reflectors that bounce-off light through a second surface to achieve the soft 3-D effect of the light. For instance, the umbrella-type reflectors, soft box, beauty dish etc. all use the reflecting mechanism in varying degrees and forms. Nevertheless, none of these have all the inventive concepts of the present invention.

For instance, the ability to reflect the light emitted by a light source onto a large reflecting surface, the ability to withstand wind and flexibility of shooting even from behind the structure through the hollow, the ability to focus the light onto a subject by standing directly behind the reflector by looking through the hollow and the ability to hold the structure using a unique locking system and to collapse the frame from both the central hub base (which is the bearing body) and its ribs for easy mobility are not found in any of the prior art.

### BRIEF DESCRIPTION OF THE DRAWINGS

FIG. 1 shows a front close-up isometric view of an embodiment of the reflector in extended position including the Light Source, Inner-Reflector and upper part of the Stand.

FIG. 2 shows the back isometric view of an embodiment of a reflector deployed in extended position without the Light Source, Adapter Ring and the Stand. FIG. 2 may be the back view of the embodiment in FIG. 1.

FIG. 3 shows the front close-up isometric view of another embodiment of the reflector when in an operating configuration.

FIG. 4 shows the back isometric view of another embodiment of a reflector deployed in extended position with a Distal-Rib connected to each Proximal-Rib, without the Light Source, Adapter Ring and the Stand. FIG. 4 may be the back view of the embodiment in FIG. 3.

FIG. 5 shows the front close-up isometric view of a further embodiment of the reflector when in an operating configuration.

FIG. 6 shows the back isometric view of another embodiment of a reflector deployed in extended position comprising two Distal-Ribs connected to each Proximal-Rib, without the Light Source, Adapter Ring and the Stand. FIG. 6 may be the back view of the embodiment in FIG. 5.

FIG. 7 shows the front view of a further embodiment of the reflector when in an operating configuration.

FIG. 8 shows the back isometric view of a further embodiment of a reflector deployed in extended position using suspension straps, without the Light Source, Adapter Ring and the Stand. FIG. 8 may be the back view of the embodiment in FIG. 7.

FIG. 9 shows a cross section side view of an embodiment similar to FIG. 7 indicating the path or direction of the light

FIG. 10 shows a cross section side view of an embodiment similar to FIG. 5 indicating the path or direction of the light.

FIG. 11 shows a close up view of the Canopy from its reflective surface and how it may be connected to the Distal-Rib in an embodiment similar to FIG. 3.

FIG. 12 shows the top view of an embodiment in FIG. 11.

FIG. 13 shows a close up view of the Canopy from its reflective surface and how it may be connected to the Distal Ribs similar to an embodiment in FIG. 5.

FIG. 14 shows the back view of an embodiment similar to FIG. 13.

FIG. 15 shows a close up view of the Canopy from its non-reflective surface and how it may be connected to the Distal-Ribs in an embodiment similar to FIG. 7 using Suspension Straps.

FIG. 16 shows a close up view of the Canopy from its non-reflective outer surface and how it may be connected to the Distal-Ribs in an embodiment similar to FIG. 7 using Suspension Pockets.

FIG. 17 shows a cross section of an embodiment of a Rib Joint with a Rod Connector that may be used in embodiments similar to FIG. 3 and FIG. 7.

FIG. 18 shows a cross section of another embodiment of a Rib Joint with a Spring Mechanism.

FIG. 19 shows a cross section of an alternative Rib Joint where the Joint is a Spring.

FIG. 20 shows the close-up view of the Hub Base and its components from the back.

FIG. 21 shows a close-up cross-section view of the Hub and its components in FIG. 20.

FIG. 22 shows the close-up view of the Hub Base and its components in FIG. 20 from the front without the Adapter Ring.

FIG. 23 shows a close-up view of the Hub from its rear end.

FIG. 24 shows different embodiments of the Inner-Reflector.

FIG. 25 shows the process of unlocking the Ribs from the Rib Holders using an Unlocking Disk for the Reflector to be brought down to a Collapsed Position.

FIG. 26 shows the close-up view of an Unlocking Disk from its rear end.

FIG. 27 shows the process of collapsing the embodiment in FIG. 7.

FIG. 28 shows the process of collapsing the apparatus in FIG. 5.

FIG. 29 shows the embodiments in FIG. 3 and FIG. 7 when in fully collapsed position

FIG. 30 shows an embodiment similar to FIG. 5 when in fully collapsed position

### DETAILED DESCRIPTION

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise. The words ‘subject’ and ‘object’ are used interchangeably and mean one and the same thing when referred to in the context of the thing being photographed or illuminated by the reflector.

Before the present invention is described in further detail, it is to be understood that the invention is not limited to the particular embodiments described, as such may vary. It is also to be understood that the terminology used herein is for the purpose of describing particular embodiments only, and is not intended to be limiting.

The present disclosure relates to a collapsible reflector which can be easily extended from a retracted position into an extended position and collapsed from the extended position to the retracted position.

The reflector comprises a frame using which a Canopy is stretched creating a hollow at the base when the reflector is extended to the operating configuration. The frame comprises a plurality of Ribs, attached to a Central Hub Base, Ribs extendable outwardly therefrom to assume a substantially parabolic concavity when in the operating configuration. The Canopy is stretched across the distal end portion of the frame, the Canopy assuming a corona shape when the reflector is in the operating configuration. A Light Source that enters through the Hub Base from the rear of the reflector may emit light onto the Canopy directly or onto an Inner-Reflector which reflects onto the canopy, and the light so directed onto the Canopy may be reflected onto an intended subject or object.

The Ribs may extend as one single rib from the Central Hub Base and support the canopy at its distal end portion. In another embodiment the Ribs may comprise multiple rib portions connected using Rib Joints wherein the Proximal-Rib will be connected to the Central Hub Base and the Distal-Rib may support or hold the Canopy. In another embodiment multiple Distal-Ribs may be connected to a single Rib Joint. The Ribs may be made of flexible or non-flexible material and accordingly, the Ribs may be flexible or rigid or non-flexible as may be useful in different embodiments. Whilst flexible Ribs allow the Canopy to assume a necessary concavity, non-flexible Distal-Ribs may assist in obtaining a flat corona shaped Canopy resulting in more spread-out light. Advantageously the Ribs may be hollow or solid inside. A hollow Rib could benefit the invention in significantly reducing the weight of the apparatus and result in easy mobility.

The inner surface of the Canopy that reflects the light onto a subject or an object may be made out of reflective material or be made reflective using a reflective substance applied on it. The Canopy may assume substantially a corona shape when extended to the operating configuration, due to the hollow intended in this invention. The Canopy may also comprise of panels in the shape of trapezoids stitched or connected together to form the corona shape. The Ribs may be connected to the canopy along the seams of the said panels if any. In another embodiment of the present invention, Straps may be connected to the Canopy by which the Ribs may suspend the canopy. In such embodiment the Ribs may not lie along the seams of the said panels. In a further embodiment the canopy may comprise pockets sewn or attached onto the non-reflective or outer-surface of the Canopy preferably connected along the seams of the panels. In such embodiment the ribs may be inserted into the Pockets and the Canopy may be suspended on the Ribs using the Pockets. In another embodiment, the Canopy may comprise Loops or Tubular Loops through which the Ribs may be inserted for stretching the Canopy on the frame. The Ribs may be placed on/above or below the Canopy or alternatingly when the Canopy is stretched on the frame.

A Clip or a Tip may be used to attach the distal end of the Rib to the Canopy and hold the Ribs and the Canopy in place on the frame.

The hollow created by the absence of the Canopy cover around the proximal end portion of the frame promotes wind permeability particularly in outdoor use. The hollow also allows a user, a photographer or a videographer to shoot from behind the reflector through the hollow without any limitation on scope and movement. A user may also easily adjust the reflector to focus on an intended subject from behind the reflector as the hollow would allow the user to see the subject through the hollow whilst adjusting the reflector. It is very beneficial where the reflector is large, obstructing the user's view of the subject.

A user can extend and retract the reflector from the Central Hub Base. The reflector may be used to reflect electromagnetic or sound waves. The reflector may in particular be used to reflect light for photography purposes.

When the reflector is extended in the operating configuration, multiple Ribs connected to the Central Hub Base are arranged 360 degrees around the Central Hub Base forming a generally parabolic shaped frame. When fully deployed into extended position, Rib Holders on the Central Hub Base may hold the Ribs in a locked position using an inter-locking mechanism. When the reflector is collapsed or folded the Locks that hold the Ribs in the Rib Holders may be released and the Ribs may be folded and stacked parallel to each other and generally perpendicular to the Central Hub Base. An Unlocking Disk may be used to unlock the Ribs from the Rib Holders.

A Light Source that enters from the rear of the Hub may emit light onto the Canopy directly or onto an Inner-Reflector. An Inner-Reflector may be placed infront of the Light Source, facing the Light Source. The Inner-Reflector may be connected to the reflector using Prongs. The Inner-Reflector may assume a conical shape, inverted conical shape or hemispherical shape or flat shape and accordingly the quantity and quality of light reflected onto the Canopy and the light reflected by the Canopy onto a subject or object may vary. Before the reflector is collapsed or folded the Inner-Reflector needs to be removed. The Inner-Reflector may be made of reflecting material or have a reflective surface.

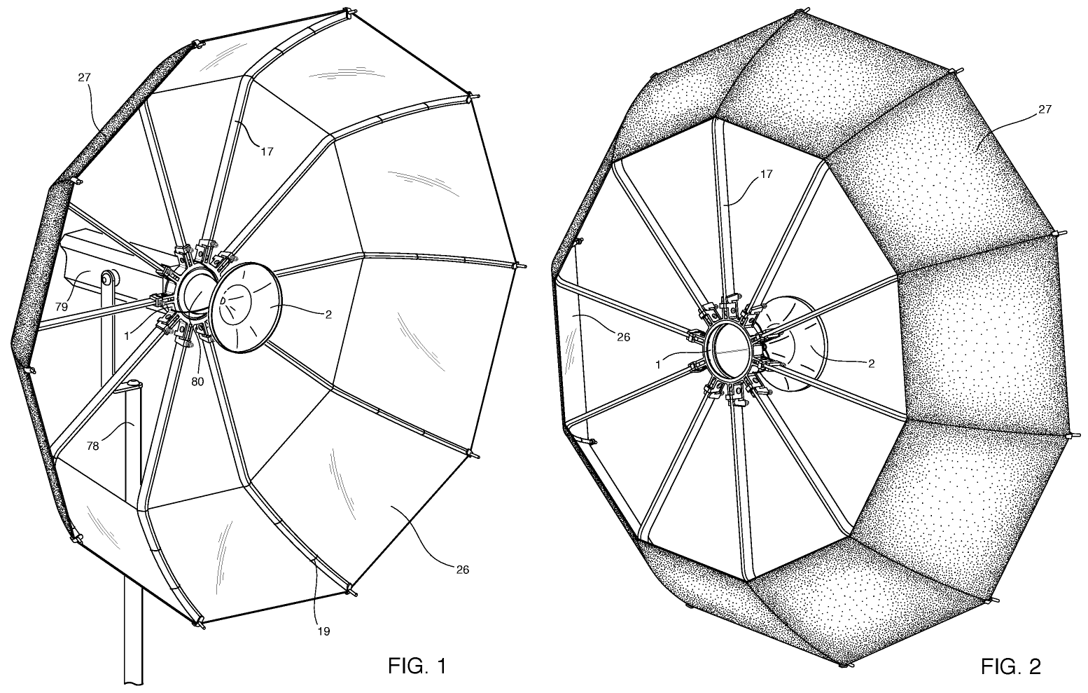

Referring now to FIGS. 1 to 30 wherein the showings are for purposes of illustrating embodiments of the present subject matter only and not for purposes of limiting same,

FIG. 1 shows a front close-up isometric view of an embodiment of the reflector in extended position according to the present invention, including the Light Source (79), Inner-Reflector (2) and upper part of the Stand (78). Ribs (17) are movably connected to the Central Hub Base (1) and extend 360 degrees around the Hub (1). Advantageously the Ribs (17) may be flexible allowing the Canopy to be stretched on the Ribs (17) to assume a generally paraboloid shape. The Canopy is stretched across the distal end portion of the Ribs (17) and rests atop the Ribs (17). The Canopy may be connected to the frame by a Stitch or multiple Stitches. The Canopy may be attached to the distal end of the Ribs through a Tip Holder. A Light Source (79) may enter the Hub (1) from its rear end and emit the light onto the Canopy (26) either directly or by an Inner-Reflector (2). An Inner-Reflector (2) may be attached to the Hub (1) in front of the Light Source (79), facing the Light Bulb (80).

FIG. 2 shows the back isometric view of an embodiment of a reflector deployed in extended position according to the present invention without the Light Source, Adapter Ring and the Stand. FIG. 2 may be the back view of the embodiment in FIG. 1.

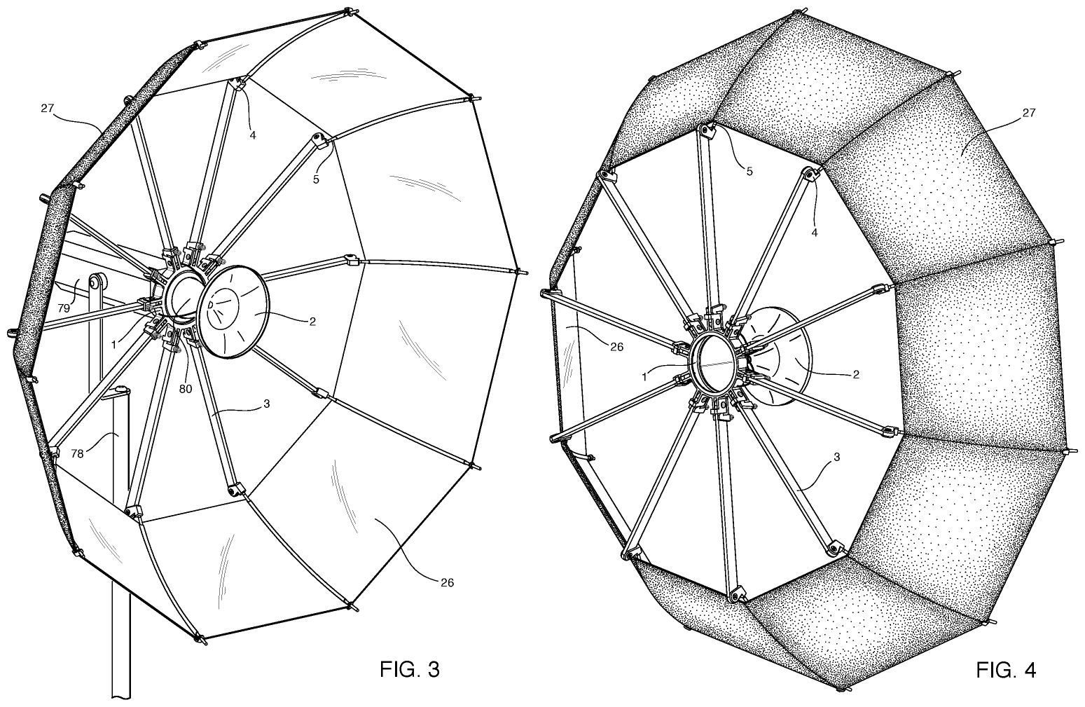

FIG. 3 shows the front close-up isometric view of another embodiment of the reflector when in an operating configuration. Proximal-Ribs (3) are movably connected to and extend 360 degrees around the Hub (1). The Proximal-Ribs (3) may be rigid or non-flexible. Distal-Ribs (5) may be connected to the Proximal-Ribs (3) longitudinally using a Joint with a Rib Connector (4). The Distal-Ribs (5) may be flexible. Advantageously the Distal-Ribs (5) may be flexible allowing the Canopy to be stretched on the Ribs (5) to assume a generally paraboloid shape. The Canopy is stretched across distal Ribs (5) and rests atop of Ribs. The Canopy may be connected to the frame by a Stitch or multiple Stitches. The Canopy may be attached to the distal end of the ribs through a Tip Holder. A Light Source (79) may enter the Hub (1) from its rear end and emit the light onto the Canopy (26) either directly or through an Inner-Reflector (2). An Inner-Reflector (2) may be attached to the Hub (1) in front of the Light Source (79), facing the Light Bulb (80).

FIG. 4 shows the back isometric view of another embodiment of a reflector deployed in extended position according to the present invention with a Distal-Rib (5) connected to each Proximal-Rib (3), without the Light Source, Adapter Ring and the Stand. FIG. 4 may be the back view of the embodiment in FIG. 3.

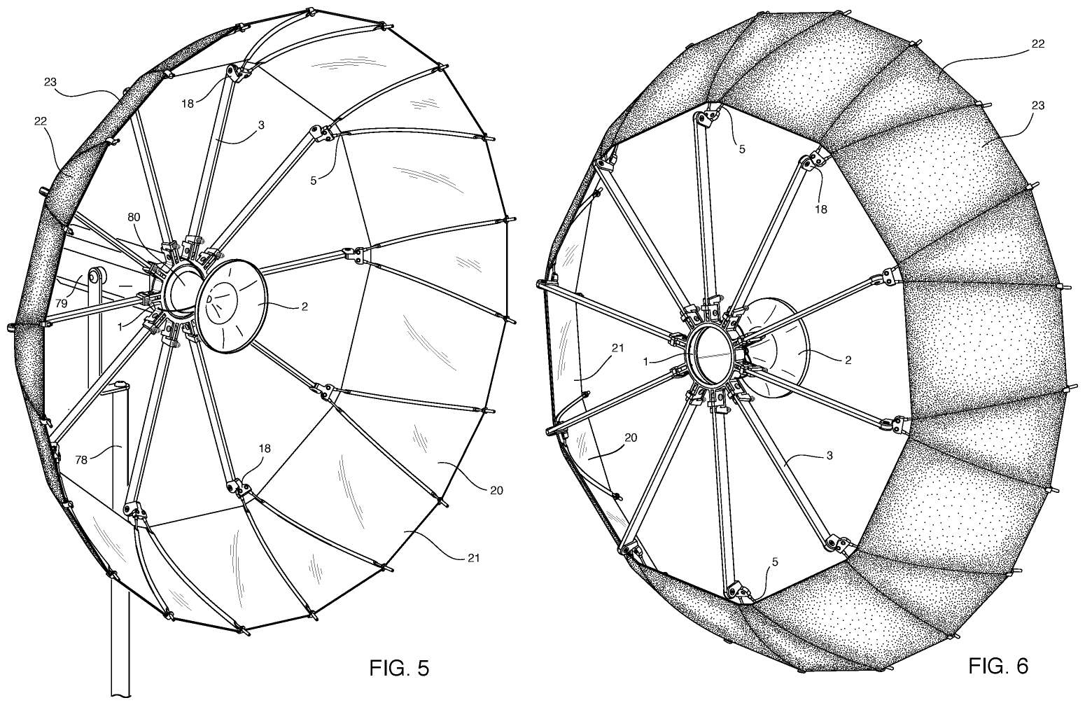

FIG. 5 shows the front close-up isometric view of a further embodiment of the reflector when in an operating configuration. Proximal-Ribs (3) are movably connected to and extend 360 degrees around the Hub (1). The Proximal-Ribs (3) may be rigid or non-flexible. Two Distal-Ribs (5) are connected longitudinally to each Proximal-Rib (3) using a Joint with a Splitter Head (18). Advantageously the Distal-Ribs may be flexible allowing the canopy to be stretched on the ribs (5) to assume a generally paraboloid shape. The Canopy is stretched across distal Ribs (5) and rests atop of Ribs (5). The Canopy may be connected to the frame by a Stitch or multiple Stitches.

The Canopy may be attached to the distal end of the Ribs through a Tip Holder. A Light Source (79) may enter the Hub (1) from its rear end and emit the light onto the Canopy (20, 21) either directly or through an Inner Reflector (2). An Inner-Reflector (2) may be attached to the Hub (1) in front of the Light Source (79), facing the Light Bulb (80). Having two Distal-Ribs (5) connected to each Proximal-Rib (3) doubles the amount of panels in the Canopy and significantly increases the reflective surface of the Canopy compared to the embodiments in FIG. 1 and FIG. 3 while also providing more support for the Canopy. The Distal-Ribs (5) may be on top or underneath the Canopy alternatingly.

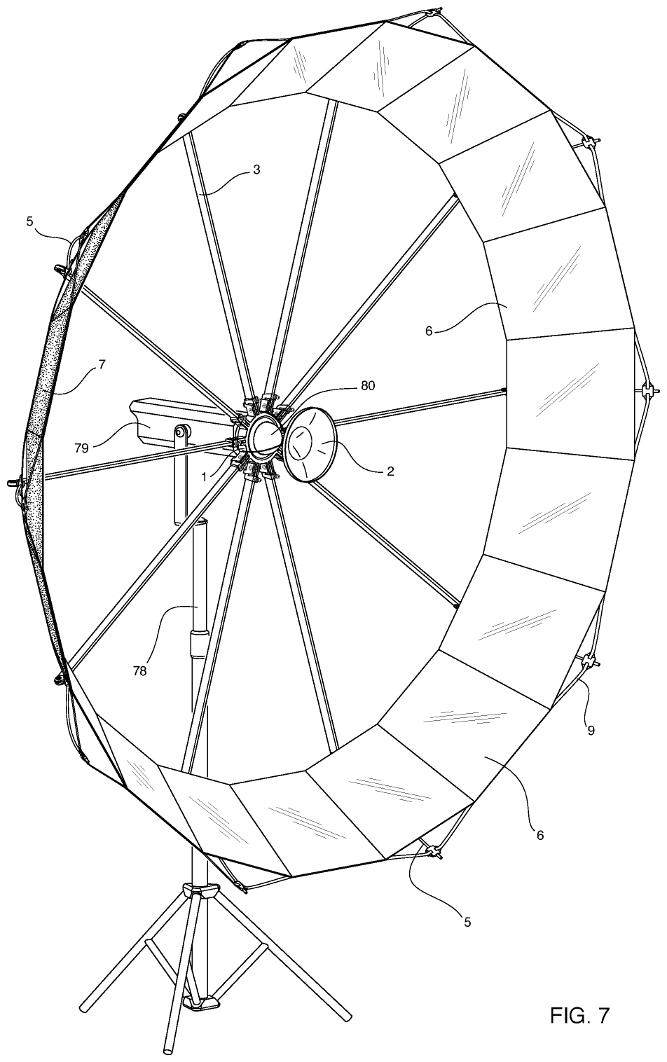

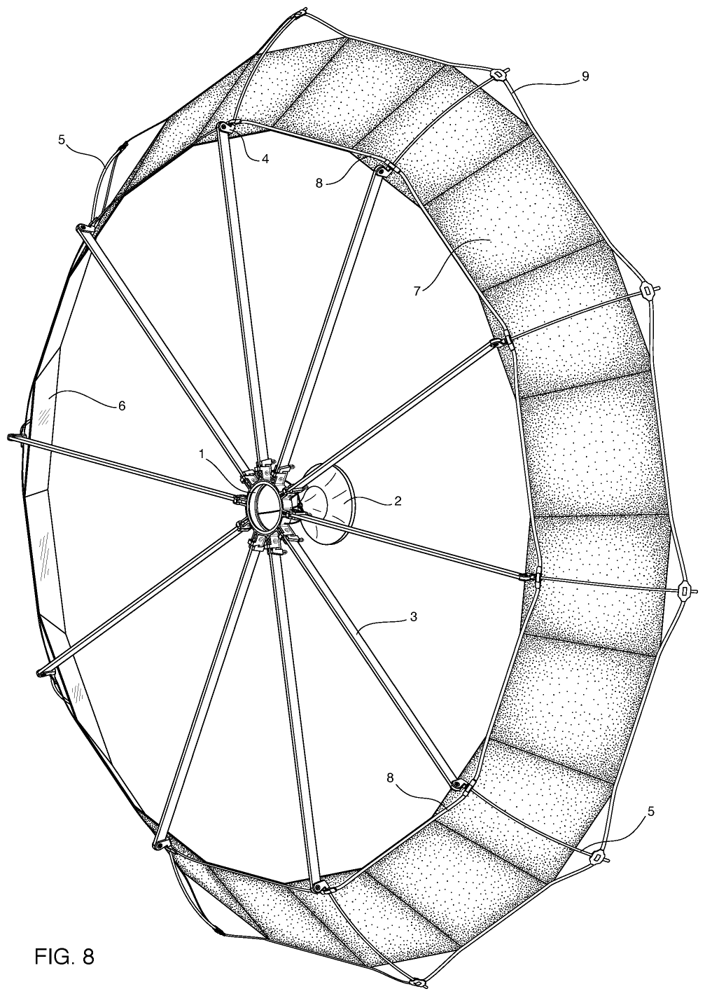

FIG. 6 shows the back isometric view of another embodiment of a reflector deployed in extended position according to the present invention comprising two Distal-Ribs (5) connected to each Proximal-Rib (3), without the Light Source, Adapter Ring and the Stand. FIG. 6 may be the back view of the embodiment in FIG. 5.

FIG. 7 shows the front view of a further embodiment of the reflector when in an operating configuration. Proximal-Ribs (3) are movably connected to and extend 360 degrees around the Hub (1). The Proximal-Ribs (3) may be rigid or non-flexible. Distal-Ribs (5) are connected longitudinally to the Proximal-Ribs (3) using a Joint with a Rib Connector (4). The Canopy is stretched while also suspended underneath Distal-Ribs (5) with Suspension Straps (8, 9). Suspension Straps (8,9) may be attached to the Canopy's non-reflective outer surface (7). Unlike in FIG. 1, FIG. 3 and FIG. 5 where the Canopy assumes a concave shape of the Distal-Ribs (5), panels of the canopy in FIG. 7 may be flat.

A Light Source (79) may enter the Hub (1) from its rear end and emit the light onto the Canopy (6) either directly or through an Inner-Reflector (2). An Inner-Reflector (2) may be attached to the Hub (1) in front of the Light Source (79), facing the Light Bulb (80).

FIG. 8 shows the back isometric view of a further embodiment of a reflector deployed in extended position according to the present invention using Suspension Straps (8,9), without the Light Source, Adapter Ring and the Stand. FIG. 8 may be the back view of the embodiment in FIG. 7.

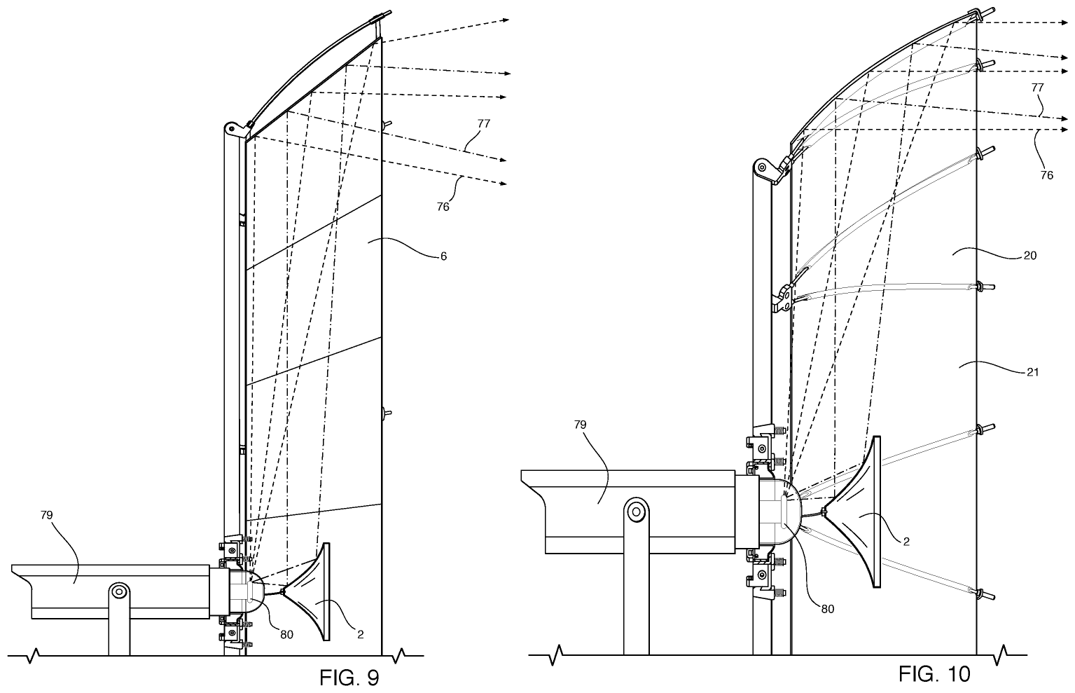

FIG. 9 shows a cross section side view of an embodiment similar to FIG. 7 indicating the path or direction of the light emitted by the Light Source (79) with a Light Bulb (80) onto the Canopy (6) directly and therefrom (76), and the path or direction of the light emitted from the Light Bulb (80) onto the Inner-Reflector (2) and reflected onto the Canopy (6) and therefrom (77). The angle of the Canopy (6) receiving the light may facilitate a more spread-out light reflected therefrom than in the embodiments in FIG. 1, FIG. 3 or FIG. 5.

FIG. 10 shows a cross section side view of an embodiment similar to FIG. 5 indicating the path or direction of the light emitted by the Light Source (79) with a Light Bulb (80) onto the Canopy (20, 21) directly and therefrom (76), and the path or direction of the light emitted from the Light Bulb (80) onto the Inner-Reflector (2) and reflected onto the Canopy (20,21) and therefrom (77). The angle and concavity of the Canopy (20, 21) receiving the light may facilitate a concentrated and more efficient light reflected therefrom than in the embodiment in FIG. 7.

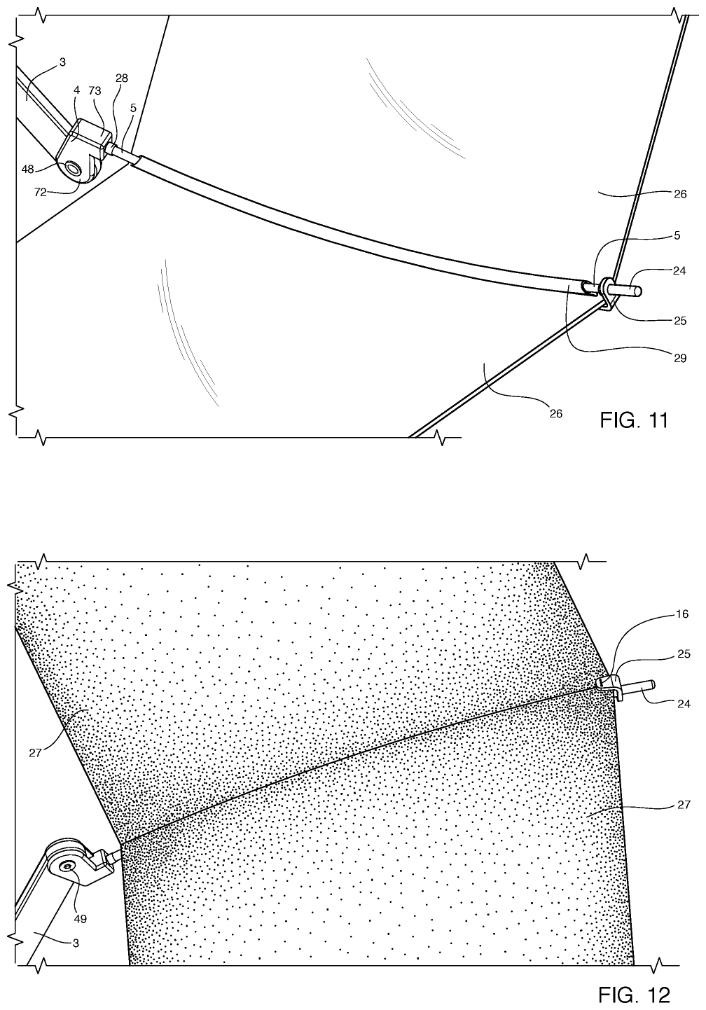

FIG. 11 shows a close up view of the Canopy (26) from its reflective surface and how it may be connected to the Distal-Rib (5) in an embodiment similar to FIG. 3. A Distal-Rib (5) may be longitudinally connected to a Proximal-Rib (3) using a Rib Joint (4). The Proximal-Rib (3) may be connected to the Rib Joint (4) by a Rivet (48). The Distal-Rib (5) may be reinforced with a Tubular Sleeve (28). The Distal-Rib (5) may comprise a threaded end which may be screwed into a Rib Joint (4) in order to connect the Distal-Rib (5) to the Rib Joint (4). The Tubular Sleeve (28) may be metallic or of a composite material. A Distal-Rib (5) may be inserted and passed through a Rib Receiving Sleeve (29) and into a Tip (24) on a Tip Holder (25) which may be used to hold and fasten the distal end of the Rib (5) to the Canopy.

FIG. 12 shows the top view of an embodiment in FIG. 11. The Tip Holder (25) may be connected to the Canopy using a Stitch or Stitches (16).

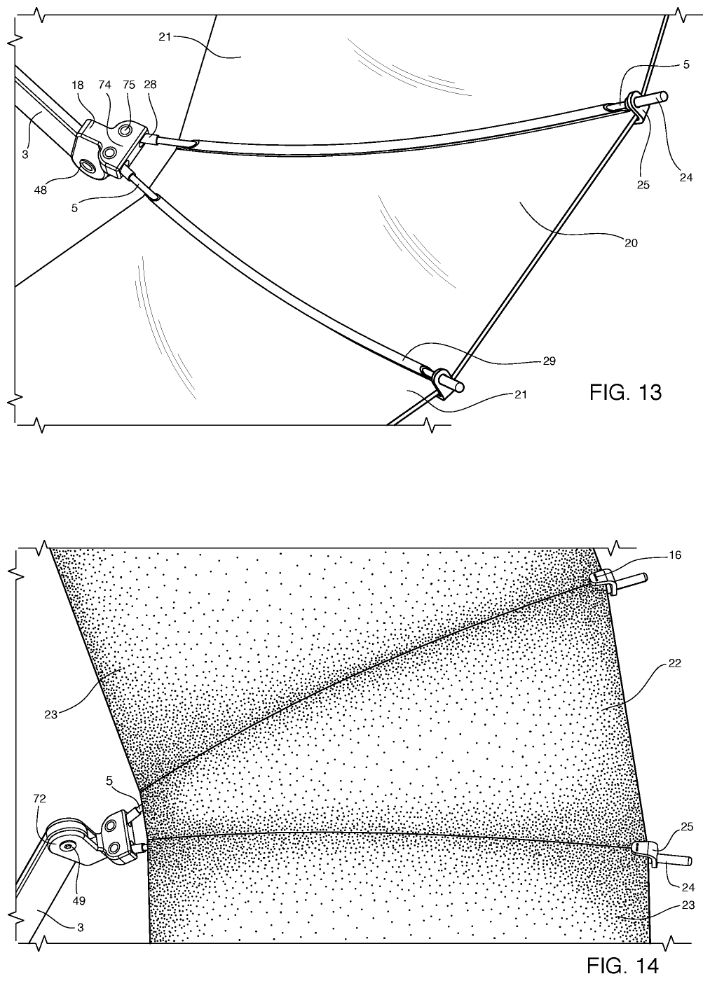

FIG. 13 shows a close up view of the Canopy from its reflective surface (20, 21) and how it may be connected to the Distal-Ribs (5) similar to an embodiment in FIG. 5. Two Distal-Ribs (5) may be longitudinally connected to a Proximal-Rib (3) using a Rib-Joint (18). A Proximal-Rib (3) can be connected to the Rib Joint (18) by a Rivet (48). The Distal-Ribs (5) may be reinforced with Tubular Sleeves (28). The Tubular Sleeve (28) may be metallic or of a composite material. The Distal-Rib (5) may comprise a threaded end which may be screwed into a Rib-Joint (18) in order to connect the Distal-Ribs (5) to the Rib Joint (18). Each Distal-Rib (5) may be inserted and passed through a Rib Receiving Sleeve (29) and into a Tip (24) on the Tip Holder (25) which may be used to hold and fasten the distal end of the Rib to the Canopy.

FIG. 14 shows the back view of an embodiment similar to FIG. 13. A Tip Holder (25) may be connected to the Canopy using a Stitch or Stitches (16).

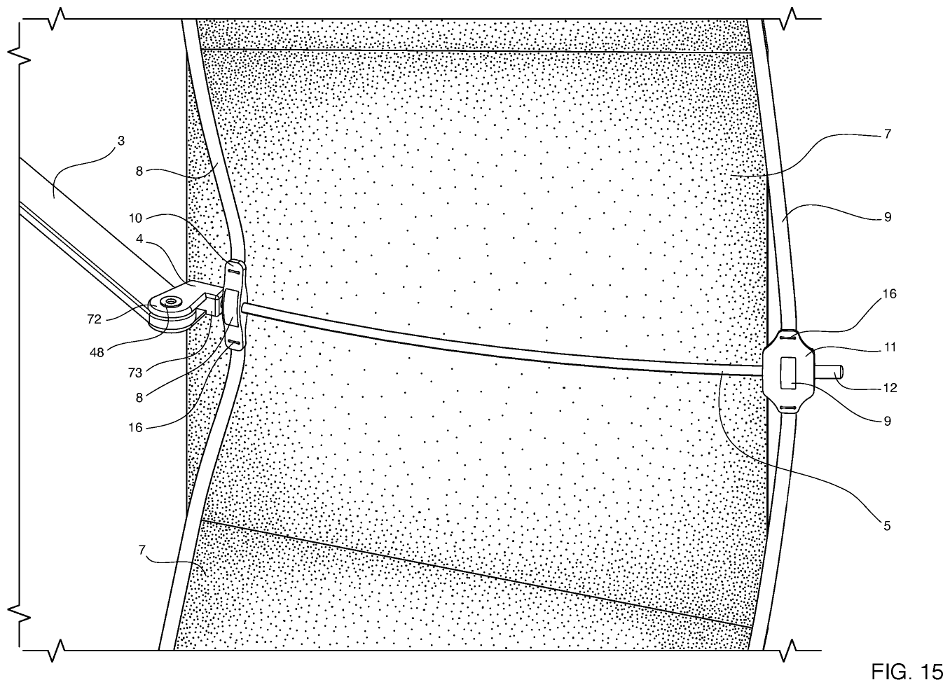

FIG. 15 shows a close up view of the Canopy from its non-reflective surface (7) and how it may be connected to the Distal-Ribs (5) in an embodiment similar to FIG. 7 using Suspension Straps (8, 9). A Distal-Rib (5) may be longitudinally connected to a Proximal-Rib (3) using a Rib Joint (4). A Proximal-Rib (3) may be connected to the Rib Joint (4) by a Rivet (48). The Distal-Ribs (5) may be reinforced with Tubular Sleeves (28). The Tubular Sleeve (28) may be metallic or of a composite material. The Distal-Rib (5) may comprise a threaded end which may be screwed into a Rib Joint (4) in order to connect the Distal Ribs (5) to the Rib Joint (4). A Bottom Suspension Holder (10) and a Top Suspension Holder (11) with a Tip (12) may be affixed to the base and top of the Distal-Rib (5) respectively. A Suspension Strap (8) may run through a Suspension Holder (10) connecting the base of the Distal-Rib (5) to the Inner Circumference of the Canopy (7). A

Suspension Strap (9) may also run through a Suspension Holder (11) connecting the distal end of the Distal-Rib (5) to the Outer Circumference of the Canopy (7). Straps (8, 9) may be connected to the Strap Holders (10, 11) using a Stitch or Stitches (16).

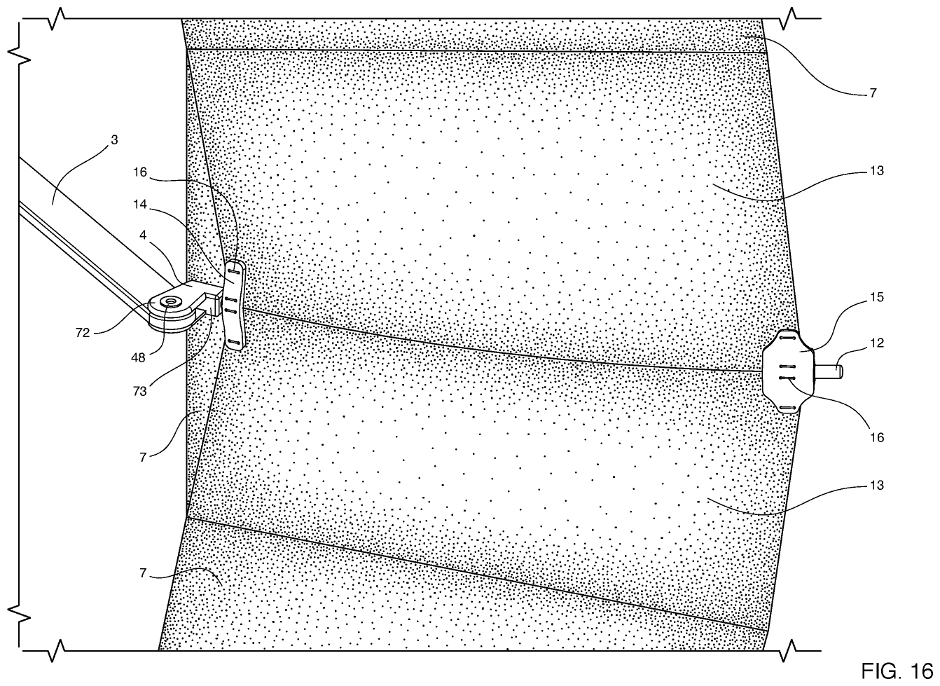

FIG. 16 shows a close up view of the Canopy from its non-reflective outer surface and how it may be connected to the Distal-Ribs (5) in an embodiment similar to FIG. 7 using Suspension Pockets (13). A Distal-Rib (5) may be longitudinally connected to a Proximal-Rib (3) using a Rib Joint (4). A Bottom Suspension Pocket Holder (14) and a Top Suspension Pocket Holder (15) with a Tip (12) may be affixed to the Bottom and Top of the Suspension Pockets (13) respectively using a Stitch or Stitches (16). Sides of the Pocket (13) may be affixed along the seams of the Panels of the Canopy (7). The Distal-Rib (5) may be inserted and passed through the Pocket (13) and into a Tip (12) of a Pocket Holder (15).

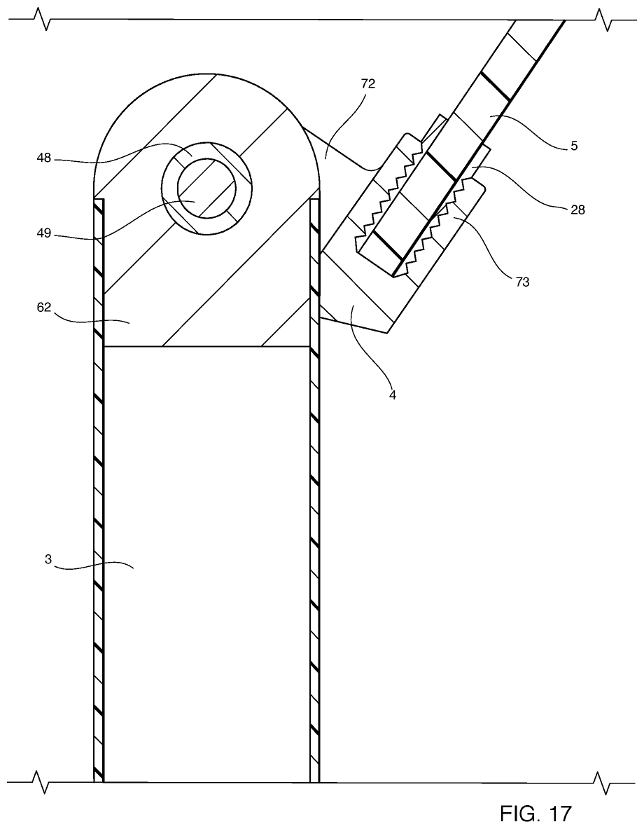

FIG. 17 shows a cross section of an embodiment of a Rib Joint (4) with a Rib Connector (73) that may be used in embodiments similar to FIG. 3 and FIG. 7. The Distal-Rib (5) is longitudinally connected to the Proximal-Rib (3) using a Rib Joint (4). A Proximal-Rib (3) may be connected to the Fork of the Joint (72) by a Rivet (48). The Distal-Rib (5) may be reinforced with a Tubular Sleeve (28). The Tubular Sleeve (28) may be metallic or of a composite material. The Distal-Rib (5) may comprise a threaded end which may be screwed into a Rib Connector of the Joint (73) in order to connect the Distal-Rib (5) to the Rib Joint (4). The Distal-Rib (5) may be flexible allowing it to form a concavity. Accordingly, the Canopy receiving the light may facilitate a concentrated and more efficient light reflected. The Distal end of the Proximal-Rib (3) may be reinforced with an Insert (62) that provides a significant durability at the point of connection of the Rib (3) with the Fork of the Joint (72).

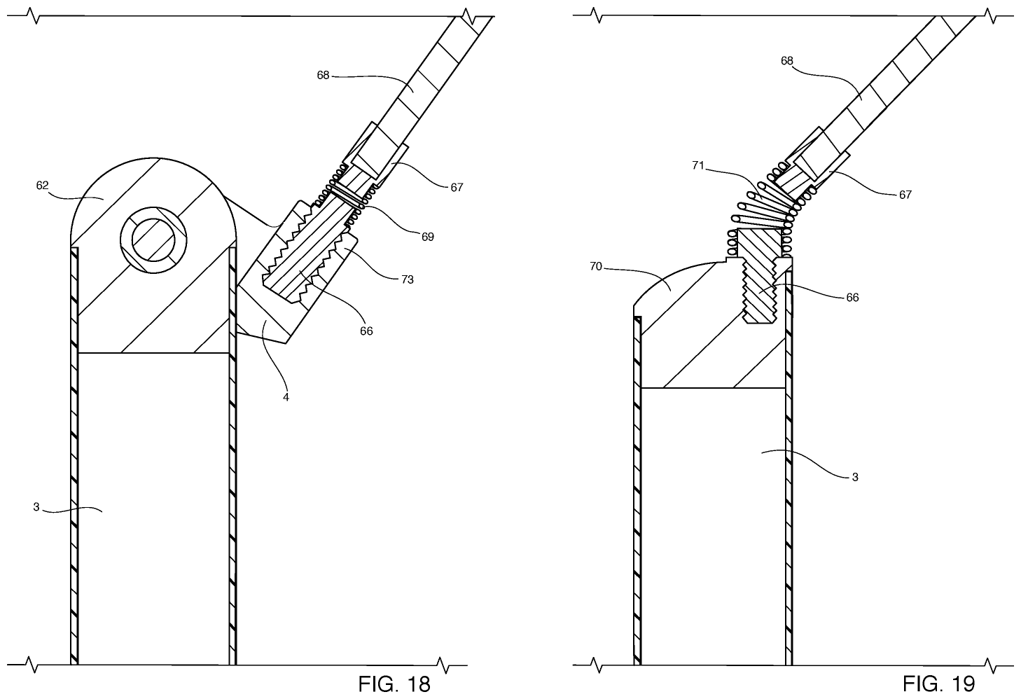

FIG. 18 shows a cross section of an alternative embodiment of a Rib Joint (4) with a Spring Mechanism. The Distal-Rib (5) may consist of a Pin (66), the Distal-Rib (68) reinforced to a Distal Rib Holder (67) and a Spring (69) between the Pin and the Distal Rib Holder (67). Having a Spring (69) at the base allows the Distal-Rib (5) to be flexible when necessary. It may also be rigid or non-flexible if no pressure is asserted onto it. The Spring mechanism may also absorb shock if the reflector falls. A rigid or non-flexible Rib may result in a flat Canopy instead of the concave shape, facilitating more spread-out light reflected therefrom than in the embodiments having curved Ribs.

FIG. 19 shows a cross section of another alternative Rib Joint where the Joint is a Spring. Unlike in FIG. 18, a Pin (66) may be screwed into Rib Insert (70) directly with a Spring (71) as a Joint in-between the Pin (66) and the Distal Rib Holder (67). Having a spring as a joint allows the Distal-Rib (68) to be non-flexible by allowing it to be bendable from the rib joint. The Spring Joint may also absorb shock if the reflector falls. A rigid or non-flexible Rib may result in a flat Canopy instead of the concave shape, facilitating more spread-out light reflected therefrom than in the embodiments having curved Ribs.

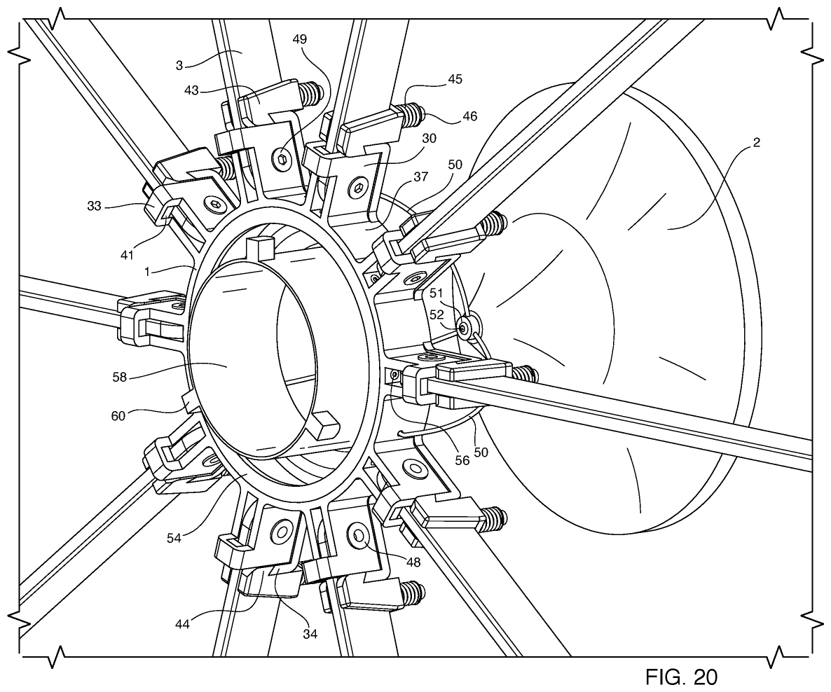

FIG. 20 shows the close-up view of the Hub Base (1) and its components from the back. An Adapter Ring (58) may be placed inside the Central Hub Base (1) as a connector between the Light Source (79) and the Reflector. An Adapter Locking Ring (54) may lock the Adapter Ring (58) in place. The Adapter Ring (58) may be connected to a Stand (78) allowing the reflector to be suspended on it. Once fixed, the Reflector is rotatable or spun around the Adapter Ring (58) similar to the motion of a wheel. The Adapter Locking Ring (54) may be fixed to the Hub (1) with screws (56), through the slots of the Rib Holders (30) and provide a significant reinforcement to the Hub (1) and making it more rigid or dense against forces that may put pressure on the Hub (1) and cause it to distort.

The Rib Locking Mechanism (42) is affixed at the base of the Proximal-Rib (3) at the front end of the Rib (3) which locks the Rib (3) to the Rib Holder (30) using an interlocking anchoring mechanism. A Rib Lock (43) is affixed to a Rib (3) with a Rib Lock Bolt (46) at the base of the Rib (3). The Rib Lock (43) comprises a hook-like protrusion (44) which may anchor onto another hook-like protrusion (34) on the Rib Holder (30). When anchored a Rib (3) is locked to its Rib Holder (30). It is very beneficial to have an interlocking mechanism where the Rib Lock (43) is interlocked with and rests atop of Plates (31) of the Rib Holder (30) when the apparatus is in the operating configuration. The Rib Lock (43) also serves the purpose of an extension to the Rib Holder (30) for better gripping of the Rib (3).

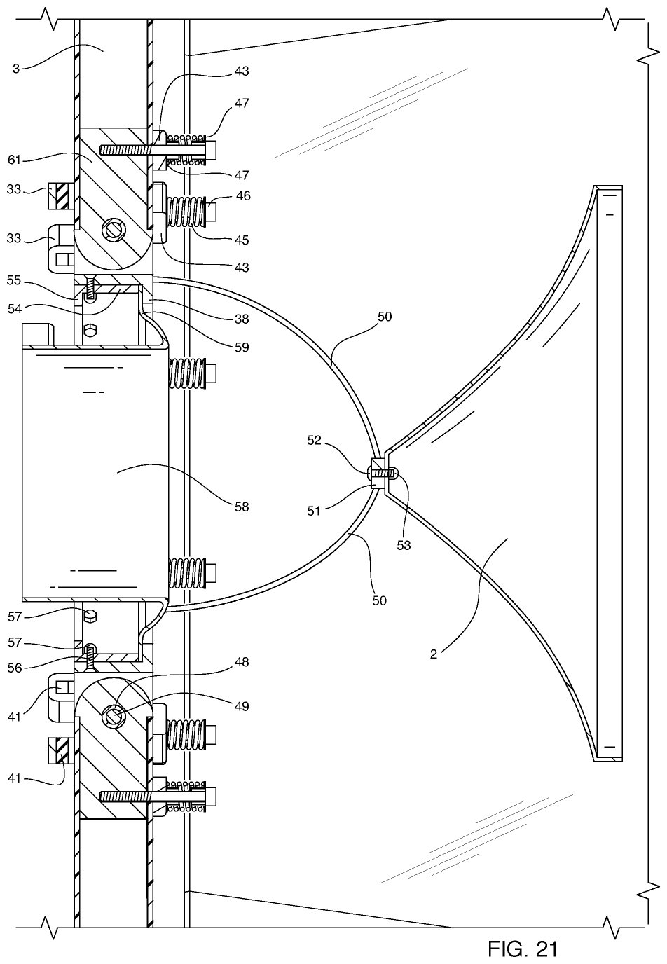

A Compression Spring (45) with Eyelets (47) on both ends of the Spring (45) may fill the space between the Rib Lock (43) and the Head of the Bolt (46) and apply constant pressure on the Rib Lock (43) to eliminate any loose connection between the Rib Lock (43) and a front edge of the Rib (3) as also shown in FIG. 21. This allows the head of the Rib Lock (43) to have a vertical movement while base of the Rib Lock (43) stays in position. An entire Rib Lock (43) can also be pushed back against the head of the Bolt (46) when necessary.

Inner-Reflector (2) may be bonded to Prong Bracket (51) with a Screw (52) and Nut (53). Prongs (50) are permanently affixed to the Prong Bracket (51).

The Bridge (33) provides rigidity to the Plates (31) of the Rib Holder (30) and may house a Rib Stopper (41). Combined, they provide the ability for the Rib (3) not to travel beyond a certain point when the apparatus is deployed to an operating configuration.

A Rib Stopper (41) may be used in the Bridge (33) of the Rib Holder (30) where the rib meets the Bridge (33) when the reflector is extended to an operating configuration. It may be made out of rubber or any pliable material. It prevents the rib from being damaged by preventing direct contact with the Bridge (33) and allows the rib (3) to travel back just enough for the Rib Locks (43) to be latched in the inter-locking position.

FIG. 21 shows a close-up cross-section view of the Hub (1) and its components in FIG. 20. An Adapter Ring (58) may be inserted into the Hub (1) from its rear end and slided all the way against the Timer-Ring (38) of the Hub (1). An Adapter Locking Ring (54) may be inserted behind Adapter Ring (58) locking the Adapter Ring (58) in place. The Adapter Locking Ring (54) may be attached to the Hub (1) with Screws (56) and Nuts (57). An Aluminium Insert (61) at the base of the Rib (3) serves a very important dual purpose. It provides significant reinforcement for the Ribs to withstand shear forces between Rib Holders and Ribs, as well as provides a base depth for the Rib Lock Bolts (46) to be screwed into and hold Rib Locks (43) firmly in position since the Ribs are Hollow in itself.

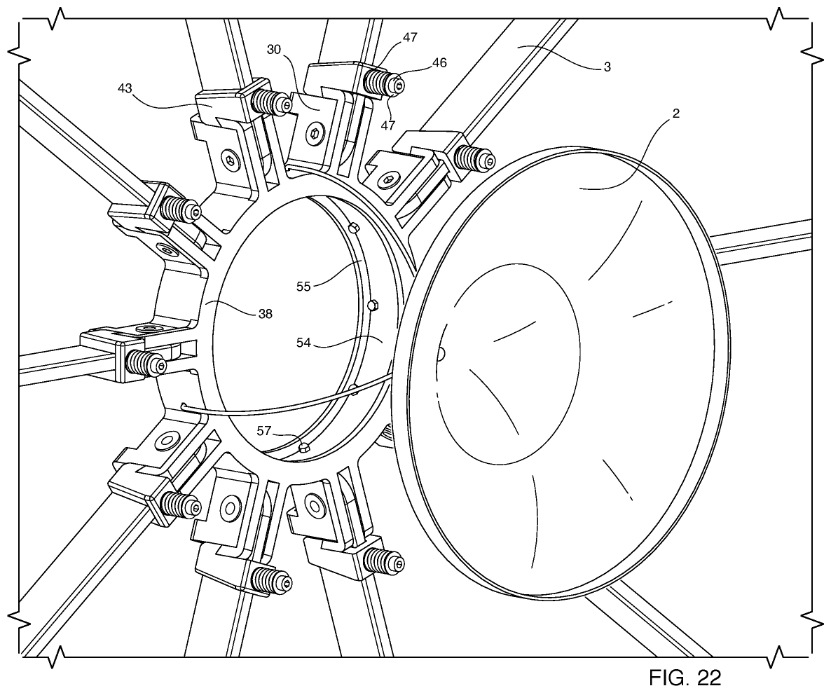

FIG. 22 shows the close-up view of the Hub Base (1) and its components in FIG. 20 from the front without the Adapter Ring (58).

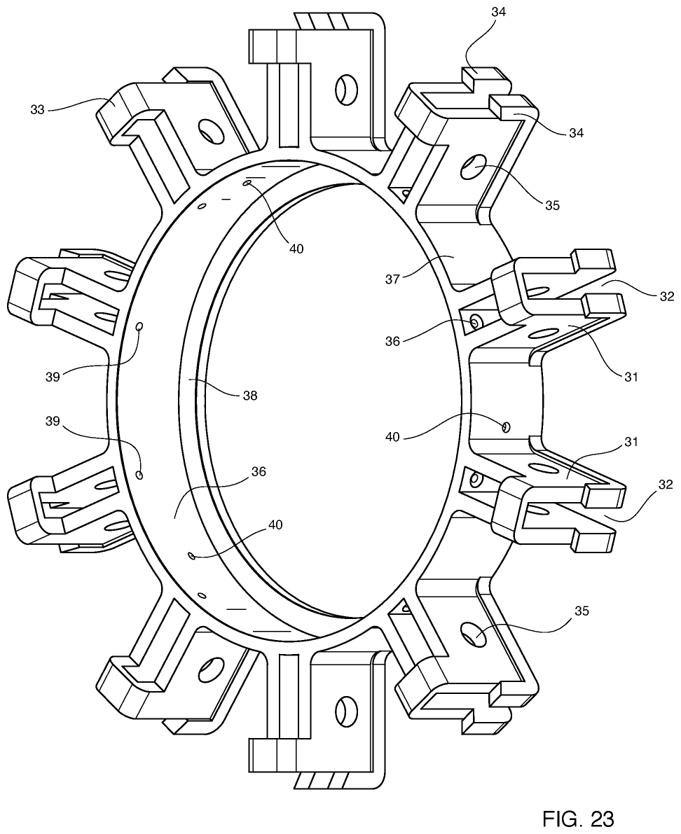

FIG. 23 shows a close-up view of the Hub (1) from its rear end.

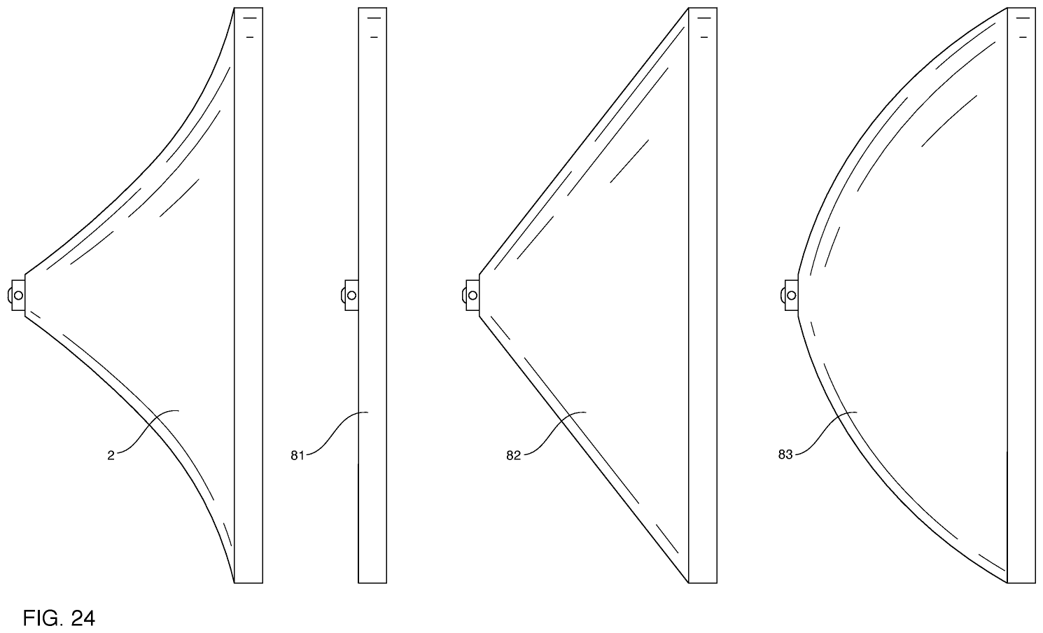

FIG. 24 shows different embodiments of the Inner-Reflector. Of these, the Conical shaped Inner-reflector (2) is preferred due to more efficient concentration of light waves onto the reflective sides of the Canopy. The Conical and Hemispherical Inner-Reflectors (82, 83) may give more spread out reflected rays of light. The Flat-shaped Inner-Reflector (81) may serve the purpose of blocking direct hard light, allowing a limited scope of light to be emitted onto the Canopy directly.

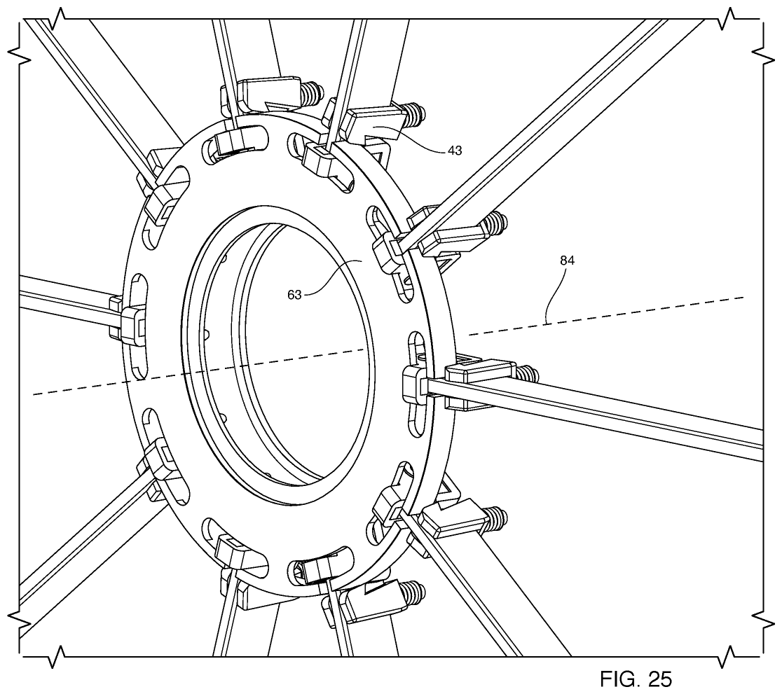

FIG. 25 shows the process of unlocking the Ribs (3) from the Rib Holders (30) using an Unlocking Disk (63) for the Reflector to be brought down to a Collapsed Position. The Unlocking Disk (63) may be inserted from the rear end of the Hub (1) lifting up all Rib Locks (43) simultaneously. The Proximal-Ribs (3) may then collapse forward. The Rib Locks (43) may also be unlocked manually one rib at a time.

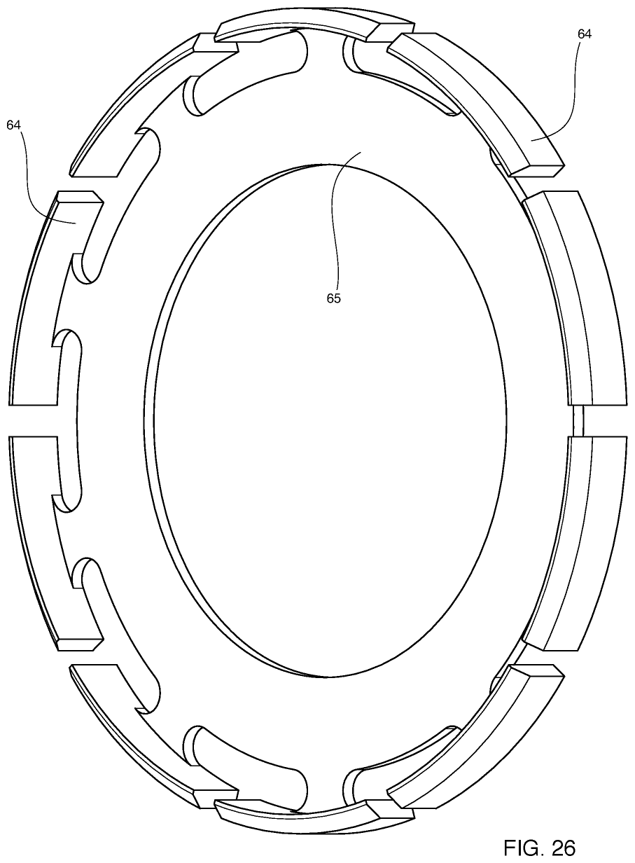

FIG. 26 shows the close-up view of an Unlocking Disk (63) from its rear end.

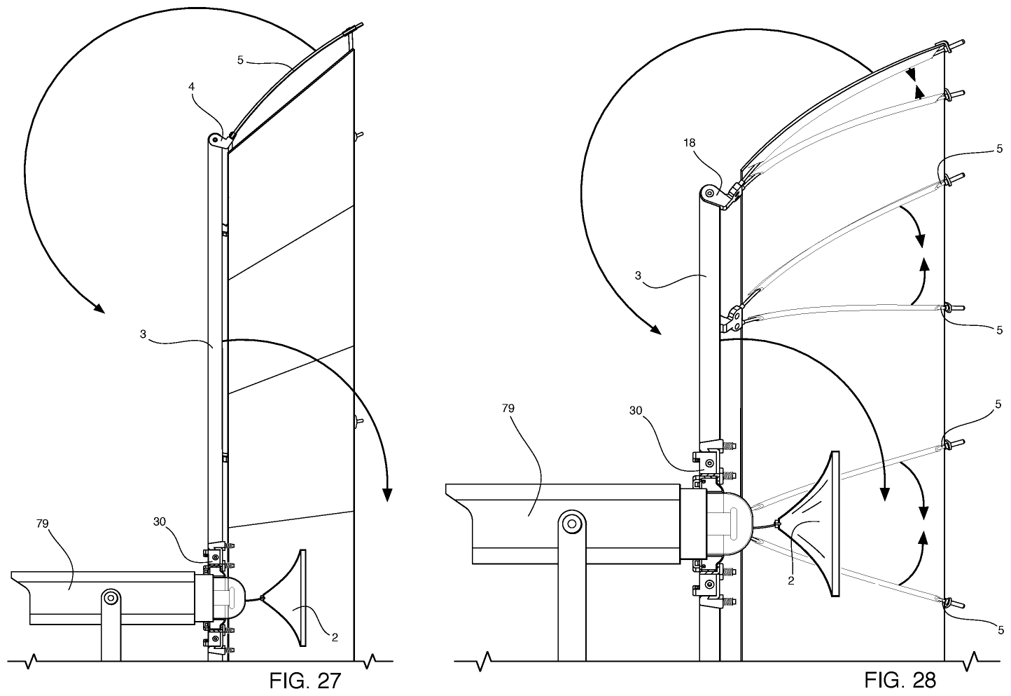

FIG. 27 shows the process of collapsing the embodiment in FIG. 7. Firstly, the Inner-Reflector is removed. Secondly, an Unlocking Disk (63) may be inserted to lift all the Rib Locks (43) simultaneously. Thirdly, the Proximal-Ribs (3) may be collapsed forward. Fourthly, the Distal-Ribs (5) may be folded backwards to rest on top of the Proximal-Ribs (3).

FIG. 28 shows the process of collapsing the apparatus in FIG. 5. Accordingly, first the Inner-Reflector is removed. Secondly the Unlocking Disk (63) may be inserted to lift all the Rib Locks (43) simultaneously. Thirdly, the Proximal-Ribs (3) may be collapsed forward. Fourthly the Distal-Ribs (5) may be folded backwards to rest on top of the Proximal-Ribs (3).

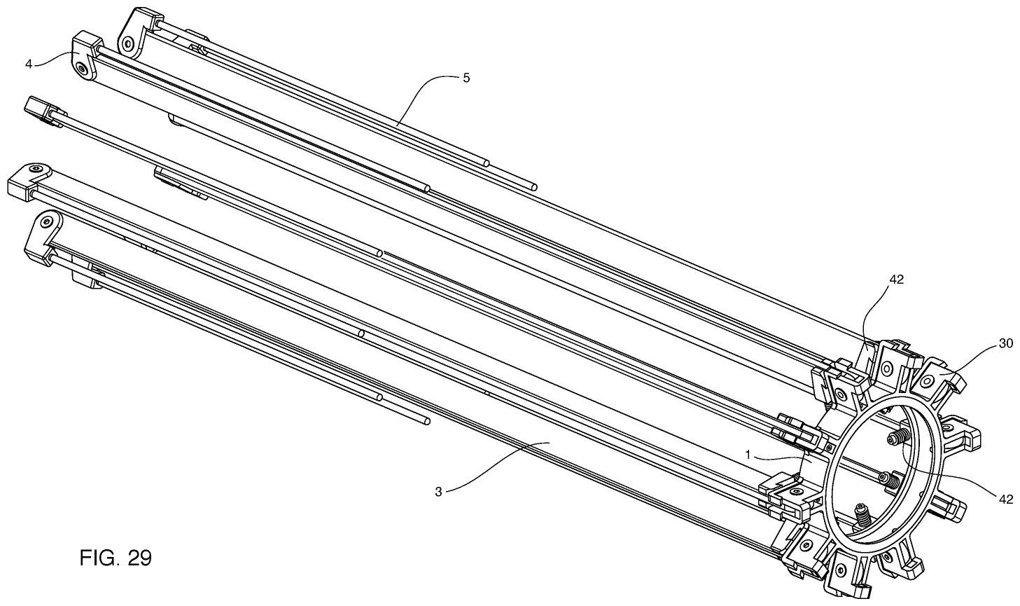

FIG. 29 shows the embodiments in FIG. 3 and FIG. 7 when in fully collapsed position.

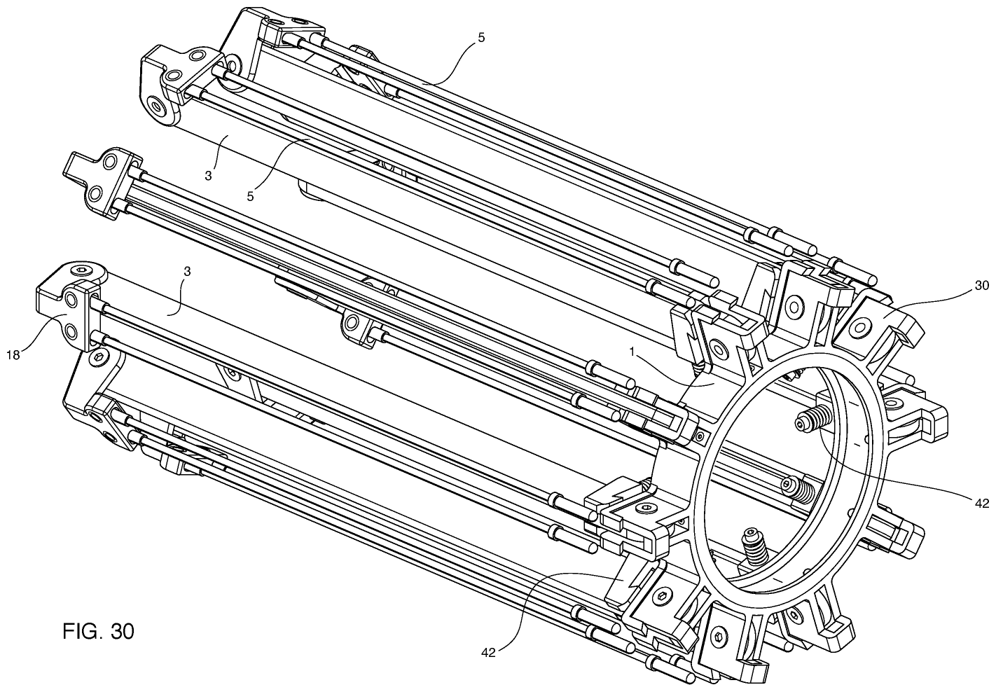

FIG. 30 shows an embodiment similar to FIG. 5 when in fully collapsed position.

It will be appreciated by one versed in the art that there are many possible variations on these designs, but all are typified by the reflecting canopy which is spread using a frame comprising ribs, forming a hollow when deployed in the extended position and the collapsibility of this frame when not in an operating configuration.

### PARTS OF THE INVENTION

1. Hub
2. Inner-Reflector
3. Proximal Rib
4. Joint with a Rib Connector
5. Distal Rib
6. Panel of the Light Reflecting Surface of the Canopy
7. Panel of the Non-reflective Surface of the Canopy
8. Suspension Strap connecting Distal Rib to the Inner Circumference of the Canopy
9. Suspension Strap connecting Distal Rib to the Outer Circumference of the Canopy
10. Bottom Suspension Holder
11. Top Suspension Holder
12. Tip
13. Suspension Pocket connecting Distal Rib to the Canopy from its Non-reflecting Surface
14. Bottom Suspension Pocket Holder
15. Top Suspension Pocket Holder
16. Stitch connecting Holder to the Canopy
17. Flexible Rib
18. Joint with a Splitter Head
19. Rib Fastening Loop
20. Panel of the Light Reflecting Surface of the Canopy connecting two Distal Ribs connected to a single Proximal Rib.
21. Panel of the Light Reflecting Surface of the Canopy connecting two Distal Ribs connected to different Proximal Ribs.
22. Panel of the Non-reflecting Surface of the Canopy connecting two Distal Ribs connected to a single Proximal Rib.
23. Panel of the Non-reflecting Surface of the Canopy connecting two Distal Ribs connected to different Proximal Ribs.
24. Tip
25. Tip Holder
26. Panel of the Light Reflecting Surface of the Canopy
27. Panel of the Non-reflective Surface of the Canopy
28. Tubular Metallic Sleeve
29. Rib Receiving Sleeve
30. Rib Holder
31. Plate of the Rib Holder
32. Slot of the Rib Holder
33. Bridge
34. Hook Shaped Interlocking Mechanism of the Rib Holder
35. Hole for the Tubular Clutch Facing Rivet to be inserted that connects Rib with the Rib Holder
36. Inner Circumference of the Hub
37. Outer Circumference of the Hub
38. Inner Ring of the Hub
39. Hole for a Screw that connects Adapter Locking Ring to the Hub
40. Hole for the Inner Reflector Prong to be inserted
41. Rib Stopper
42. Rib Locking Mechanism
43. Rib Lock
44. Hook Shaped Interlocking Mechanism of the Rib Lock
45. Spring of the Rib Locking Mechanism
46. Bolt of the Rib Locking Mechanism
47. Eyelet
48. Tubular Clutch Facing Rivet
49. Screw for Tubular Clutch Facing Rivet
50. Prong of the Inner Reflector
51. Prong Bracket
52. Screw
53. Nut
54. Adapter Locking Ring
55. Inner-Ring of the Adapter Locking Ring
56. Screw
57. Nut
58. Adapter Ring
59. Outer Ring of the Adapter Ring
60. Tooth of the Adapter Ring
61. Base Rib Insert
62. Top Rib Insert (Actual)
63. Unlocking Disk
64. Tooth of Unlocking Disk
65. Inner-Ring of the Unlocking Disk
66. Pin
67. Distal Rib Holder
68. Non-Flexible Distal Rib
69. Spring
70. Rib Top Insert
71. Spring Joint
72. Fork of the Joint
73. Rid Connector of the Joint
74. Splitter Head of the Joint
75. Centre Block
76. Light Ray reflected off of the Light Reflecting Surface of the Canopy directly from the Light Source
77. Light Ray Reflected off of the Light Reflecting Surface of the Canopy from the Light Source through Inner Reflector
78. Light Stand
79. Light Source
80. Light Bulb
81. Flat Shaped Inner-Reflector
82. Conical Shaped Inner-Reflector
83. Hemispherical Inner-Reflector
84. Imaginary central axis of the central hub base

1-55. (canceled)

56. A reflecting apparatus comprising:
a central hub base;
a frame comprising a plurality of ribs, attached to the central hub base, ribs extendable outwardly therefrom to assume a substantially parabolic concavity;
a canopy stretched across the distal end portion of the frame;
wherein the canopy is a substantially corona shape when the apparatus is in the operating configuration and the proximal end portion of the frame is uncovered by the canopy forming a hollow.

57. The apparatus of claim 56, wherein at least one rib is at least one of:
flexible;
forked at an end;
having split ends;
bendable using a rib joint;
having multiple parts, each connected longitudinally by the rib joint;
having a distal-rib and a proximal-rib, each connected longitudinally by the rib joint;
extending 360 degrees around the hub when in the operating configuration; and
inserted into a slot and movably connected to a rib holder by a bolt,
wherein the rib joint has at least one of:
a spring mechanism to attach the rib parts; and
a pivotal attachment,
wherein the slot is space created by two plates erected parallel to each other and perpendicularly on the outer rim of the central hub,
wherein the two plates are connected by a bridge at the top rear end of the plates, perpendicularly to the plates, and
wherein the bridge houses a rib stopper.

58. The apparatus of claim 57, wherein the frame is at least one of:
attachable directly or indirectly to a stand;
collapsible, from an operating configuration in which the ribs are extended, to a retracted position in which the ribs are stacked parallel to each other and the imaginary central axis of the hub base;
collapsible from the rib holders; and
collapsible from the rib joints.

59. The apparatus of claim 57, further comprising:
a hook-shaped, anchoring type protrusion as an interlocking mechanism on top of the plates.

60. The apparatus of claim 56, wherein the rib comprises a hook-shaped anchoring type protrusion as an interlocking mechanism, at the proximal end portion of the rib that connects to the central hub base, the hook-shaped anchoring type protrusion is connected to a rib end by a bolt, and a spring or rubber or other pliable material is fixed between the locking mechanism and the bolt.

61. The apparatus of claim 56, wherein the proximal end portions of the frame have proximal end portions of the ribs connected to the central hub base.

62. The apparatus of claim 56, wherein the canopy is at least one of:
wind permeable;
reflective;
stretched across the frame, on top of each rib with a sleeve or fastening means on the inner side of the canopy for receiving a rib;
stretched across the frame, underneath each rib with the sleeve or the fastening means on the outer side of the canopy for receiving the rib;
stretched across the frame in a manner where the canopy runs on top and underneath the ribs;
suspended underneath the ribs, with pockets located axially with an opening allowing the distal end of the rib to be inserted; and
suspended underneath the ribs with suspension straps connecting the distal end portions of the ribs to the canopy.

63. The apparatus of claim 56, wherein the distal end portion of the frame has at least one of:
distal end portions of the ribs; and
multiple parts of the rib.

64. The apparatus of claim 56, further comprising an inner-reflector,
wherein the inner-reflector is at least one of:
conical shaped;
inverted-conical shaped;
flat shaped;
hemispherical shaped;
placed in front of a light source; and
attached to the central hub base by prongs,
and
wherein the outer surface of the inner-reflector faces the light.

65. The apparatus of claim 56, wherein the central hub base comprises at least one of:
multiple inner rings;
an adapter-ring inserted into the central hub base from its rear end, and wherein the adapter ring is rotatably connected to the central hub base by an adapter-locking-ring which is inserted from the rear end of the central hub base behind the adapter ring;
an opening through which a light source is inserted;
rib holders, to which the ribs are movably connected,
and
wherein the rib holders hold the ribs in a locked position when deployed in an operating configuration, and the rib holders are arranged in 360 degrees around the central hub base.

66. A collapsible reflecting apparatus comprising:
a central hub base;
rib holders connected to the central hub base;
a frame comprising a plurality of ribs, movably attached to the rib holders;
a hook-shaped protrusion on the rib holder;
a matching hook-shaped protrusion on a rib lock attached to the proximal end portion of a movably connected rib;
wherein a rib latches onto a rib holder by a rib lock and locks the rib in the rib holder by the hook-shaped protrusion on the proximal end portion of the rib, anchoring onto the matching hook-shaped protrusion on the rib holder, when the reflector is extended to an operating configuration.

67. The apparatus of claim 56, wherein at least one rib is at least one of:
flexible;
forked at an end;
having split ends;
bendable using a rib joint;
having multiple parts, each connected longitudinally by the rib joint;
having a distal-rib and a proximal-rib, each connected longitudinally by the rib joint;
articulated around the hub, ninety degrees perpendicular to the imaginary central axis of the central hub base;
articulated around the hub, less than ninety degrees perpendicular to the imaginary central axis of the central hub base;
articulated around the hub, more than ninety degrees perpendicular to the imaginary central axis of the central hub base;
extending 360 degrees around the hub when in the operating configuration; and
inserted into a slot and movably connected to the rib holder by a bolt,
wherein the rib joint has at least one of:
a spring mechanism to attach the rib parts; and
a pivotal attachment,
wherein the slot is space created by two plates erected parallel to each other and perpendicularly on the outer rim of the central hub,
wherein the two plates are connected by a bridge at the top rear end of the plates, perpendicularly to the plates, and
wherein the bridge houses a rib stopper.

68. The apparatus of claim 67, wherein the frame is at least one of:
attachable directly or indirectly to a stand;
collapsible, from an operating configuration in which the ribs are extended, to a retracted position in which the ribs are stacked parallel to each other and the imaginary central axis of the hub base;
collapsible from the rib holders; and
collapsible from the rib joints.

69. The apparatus of claim 67, further comprising:
a hook-shaped, anchoring type protrusion as an interlocking mechanism on top of the plates.

70. The apparatus of claim 66, wherein the rib comprises a hook-shaped anchoring type protrusion as an interlocking mechanism, at the proximal end portion of the rib that connects to the central hub base, the hook-shaped anchoring type protrusion is connected to a rib end by a bolt, and a spring or rubber or other pliable material is fixed between the locking mechanism and the bolt.

71. The apparatus of claim 66, wherein the proximal end portions of the frame has proximal end portions of the ribs connected to the central hub base.

72. The apparatus of claim 66, further comprising an inner-reflector,
wherein the inner-reflector is at least one of:
conical shaped;
inverted-conical shaped;
flat shaped;
hemispherical shaped;
placed in front of a light source; and
attached to the central hub base by prongs,
and
wherein the outer surface of the inner-reflector faces the light.

73. The apparatus of claim 66, wherein the central hub base comprises at least one of:
multiple inner rings;
an adapter-ring inserted into the central hub base from its rear end, and wherein the adapter ring is rotatably connected to the central hub base by an adapter-locking-ring which is inserted from the rear end of the central hub base behind the adapter ring; and
an opening through which a light source is inserted.
